(19) United States
(12) Patent Application Publication
(10) Pub. No.: US 2003/0088488 A1
(43) Pub. Date: May 8, 2003

(54) System and method for firm underwritten equity facility (FUEL)

(75) Inventors: Jeff Solomon, Larchmont, NY (US); Marran Ogilvie, New York, NY (US); Jeffrey Smith, New York, NY (US)

Correspondence Address: FAY KAPLUN & MARCIN, LLP, 15O BROADWAY, SUITE 702, NEW YORK, NY, 10038, US

(73) Assignee: Ramius Capital Group, LLP

(21) Appl. No.: 09/757,215

(22) Filed: Jan. 9, 2001

Related U.S. Application Data
(60) Provisional application No. 60/241,771, filed on Oct. 19, 2000.

(51) Int. Cl. G06F 17/60

(52) U.S. Cl. 705/35; 705/4

(57) ABSTRACT

A method for raising capital comprises the steps of generating between a first company and a second company a first agreement granting the first company an option to obligate the second company to sell a predetermined volume of equity in the first company according to a predefined price structure, during a predefined time period and generating a second agreement between the first company and a third company, wherein, under the second agreement the third company is obligated to remedy a predefined failure of the second company to fulfill its obligations under the first agreement.

### FIELD OF THE INVENTION

The present invention relates to methods of raising equity capital for a company.

### BACKGROUND INFORMATION

Generally, a company may raise capital by selling its equity to public markets. This process, which is shown in FIGS. 1 and 2, is called “underwriting.” The underwriting process is initiated when an Issuer 10 hires an investment banking firm (“Underwriter 20”) to raise capital through offering the Issuer 10's equity (e.g., its common shares) (“Offering”) to the public markets 40 (step 105).

There are two main varieties of these Offerings. The first time that the Issuer 10 accesses the public markets 40, the Issuer 10 conducts an Initial Public Offering (“IPO”). On the other hand, if the Issuer 10 has already raised capital in the public markets 40, then the Issuer 10 may conduct what is known as a Follow-On Offering (“Follow-On Offering”).

The first step for the Underwriter 20 is to conduct a due diligence review of the Offering (step 110). The due diligence review usually involves a detailed review of the Issuer 10's financial statements, its performance and its prospects for the future, etc. After the due diligence review has been completed and the Underwriter 20 is satisfied with the results of this review, the counsel for the Issuer 10 and the Underwriter 20 prepare a prospectus of the Offering. The prospectus discloses certain information regarding the financial condition of the Issuer 10 and the terms of the Offering (step 115).

Subsequently, the prospectus is filed with a Regulatory Agency 30 (e.g., the Securities and Exchange Commission) (step 120). The Regulatory Agency 30 reviews the prospectus to determine whether the prospectus complies with applicable laws and regulations and provides adequate disclosure regarding financial risk factors of the company and risk factors associated with making an investment in the company. Upon determining that the prospectus is in compliance, the Regulatory Agency declares the prospectus to be “effective” (step 125). Simultaneously, the Underwriter 20 and the Issuer 10 may market the prospectus to the public (e.g., by publishing “red herring” ads) (step 130).

In step 132, the Underwriter 20 determines, in view of particular market conditions, the key terms of an Offering. In particular, the Underwriter 20 must find a group of potential buyers willing to purchase a certain volume of the Issuer 10's equity and ascertain the conditions under which they are willing to make such a purchase. Based on the demand from this group of buyers and other market conditions, the Underwriter 20 determines a price, volume and timing of the Offering. For example, it is common for the Underwriter 20 to increase the size and/or price of the Offering when it has received a large number of orders which exceed the original volume of the proposed Offering.

The Offering is considered to be closed when the deal is done, e.g., when the willing group of buyers is found at a particular price the Underwriter 20 is looking for (step 135). Subsequently, when the Issuer 10's equity is sold to the public market 40, the Underwriter 20 obtains its commission.

In certain circumstances, the public markets 40 may be unreceptive to Follow-On Offerings or the Underwriter 20 may not be interested in conducting a Follow-On Offering for a particular Issuer 10. Follow-On Offerings may also entail considerable expense to the Issuer 10 and often present significant risks. For example, a Follow-On Offering may be postponed or cancelled for market reasons or the Underwriter 20 may set a price for the equity which is undesirable to the Issuer 10.

Furthermore, there may be a long delay between the time at which the Issuer 10 decides to conduct a Follow-On Offering and the actual date of the Offering. During the intervening time, market conditions may change significantly. This imposes an added layer of risk in that, by the time of the Offering, the previously set price may have become unacceptable to the Issuer 10. For example, the Issuer 10's stock may be trading at $25.00 per share when the Issuer 10 decides to conduct a Follow-On Offering. If, by the time steps 105 through 135 are performed, the stock is trading at $10.00 per share, the Issuer 10 may be counting on the capital that it feels that it has no choice but to go forward with the Offering at this unacceptable price.

Thus, for the reasons stated above, Follow-On Offerings are often considered an inefficient way to raise capital. Another option is for the Issuer 10 to raise equity capital by utilizing a series of private offerings of common stock with subsequent registration of the common stock (i.e., a serial private placement). The private offerings may be offered to Qualified Institutional Buyers (“QIB”) as defined by applicable laws. Private offerings offer the Issuer 10 the ability to structure private placement transactions as a series of private placement transactions with multiple optional tranches. Such transactions provide certain benefits to the Issuer 10 (e.g., ability to continuously raise capital) and the terms of transactions provide for market derived pricing during a predetermined valuation period. For example, if the Issuer 10 wants to sell $1 million worth of its stock over the next 10 days, the pricing may be a percentage (e.g., 90%) of a 10 day average price for the stock. Thus under a serial private placement, a QIB may be confident that it will be able to sell stock during the valuation period under conditions virtually ensuring a gain equal to the 10% discount from the purchase price.

However, serial private placements also present certain disadvantages to the Issuer 10. Because the price is not determined until sales are made, the number of shares required to make up the desired amount of capital is not completely controllable by the Issuer 10. Under serial private placements, due to market fluctuations, the Issuer 10 does not have absolute control over either the price at which this stock is sold or the amount of shares to be sold. For instance, if the stock price falls precipitously during the 10-day valuation period, the Issuer 10 may have to sell stock at a decreasing share price. For this reason, deals often include a floor price so that if the stock trades below the floor price, the QIB is no longer obligated to purchase the stock. Therefore, the QIB may make a profit from short selling above the floor price and repurchasing stock below the floor price. In this case, the Issuer 10 will raise no capital.

Thus, to a large extent, there has not been a suitably effective and efficient method for raising capital which provides to a company sufficient control over the terms an Offering of its equity.

### SUMMARY OF THE INVENTION

The present invention is directed to a method for raising capital comprising the steps of generating between a first company and a second company a first agreement granting the first company an option to obligate the second company to sell a predetermined percentage of the first company's average trading volume of equity during a predefined time period according to a predefined price structure and generating a second agreement between the first company and a third company, wherein, under the second agreement the third company is obligated to remedy a predefined failure of the second company to fulfill its obligations under the first agreement.

### BRIEF DESCRIPTION OF DRAWINGS

FIG. 1 shows a conventional system for raising equity capital for a company from public markets.

FIG. 2 is a flowchart illustrating a conventional process for raising equity capital.

FIG. 3 shows an exemplary system which may be utilized to implement the Firm Underwritten Equity Facility process according to the present invention.

FIGS. 4a and 4b illustrated a flowchart showing a process for raising capital utilizing the Firm Underwritten Equity Facility process according to the present invention.

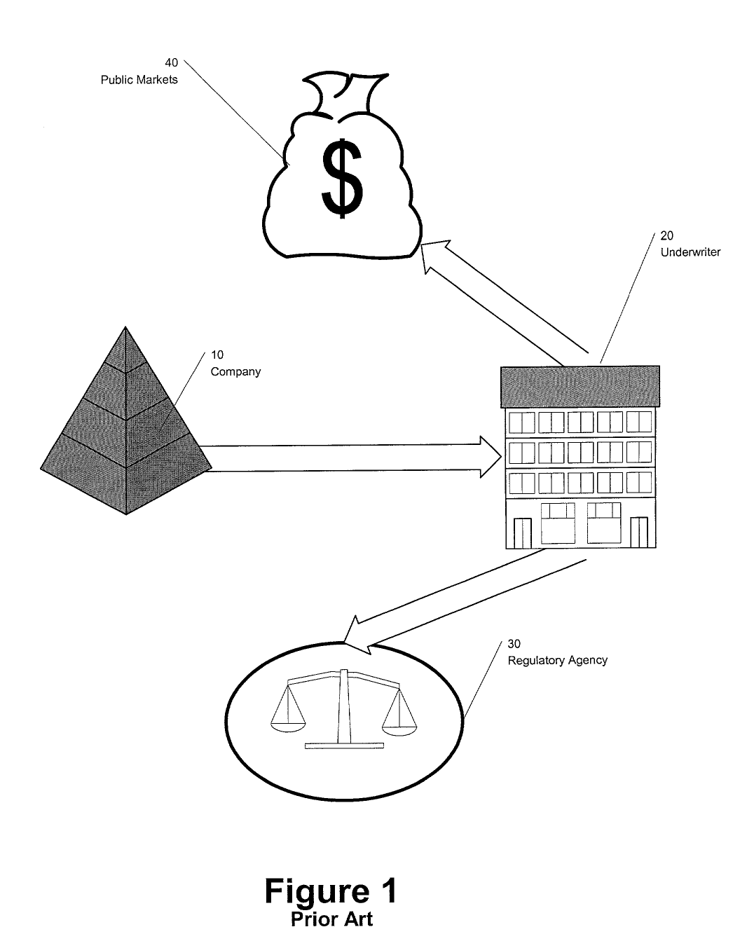

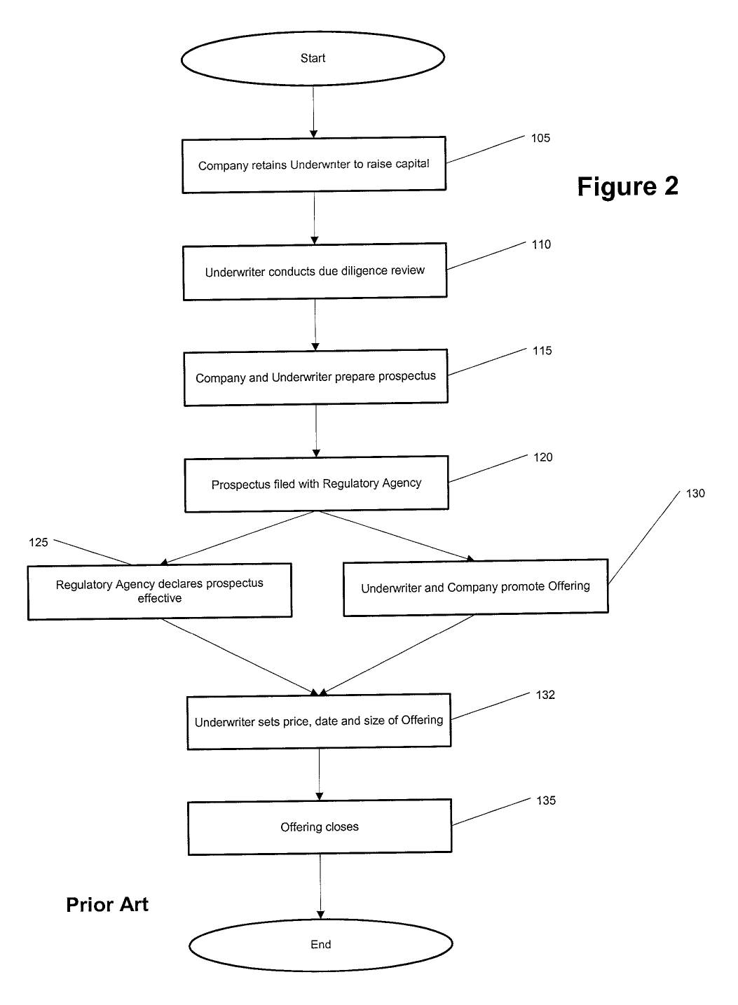

### DETAILED DESCRIPTION

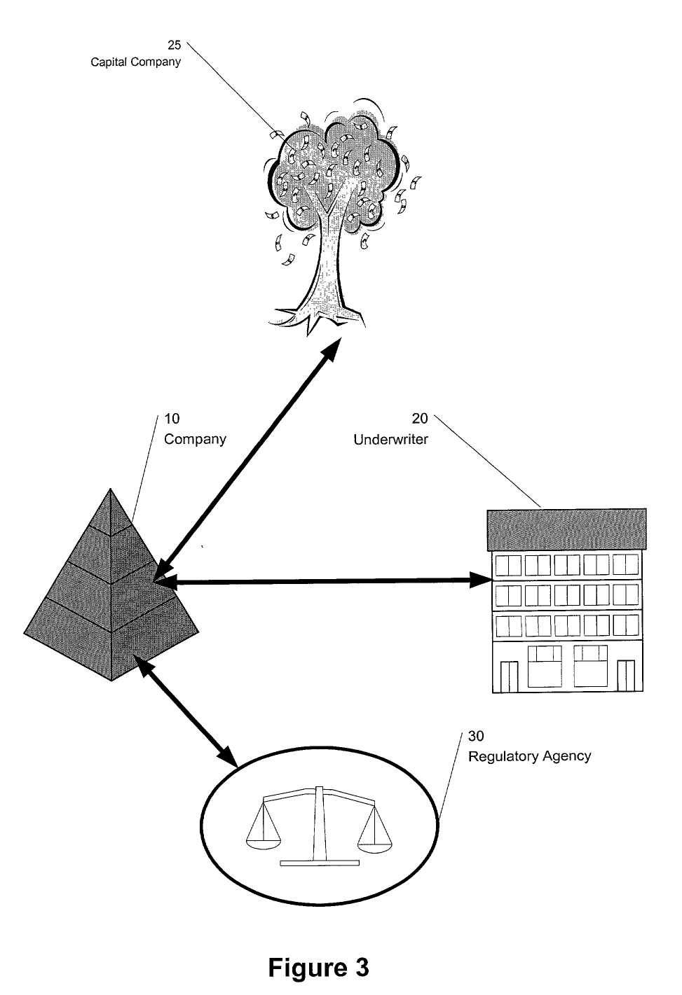

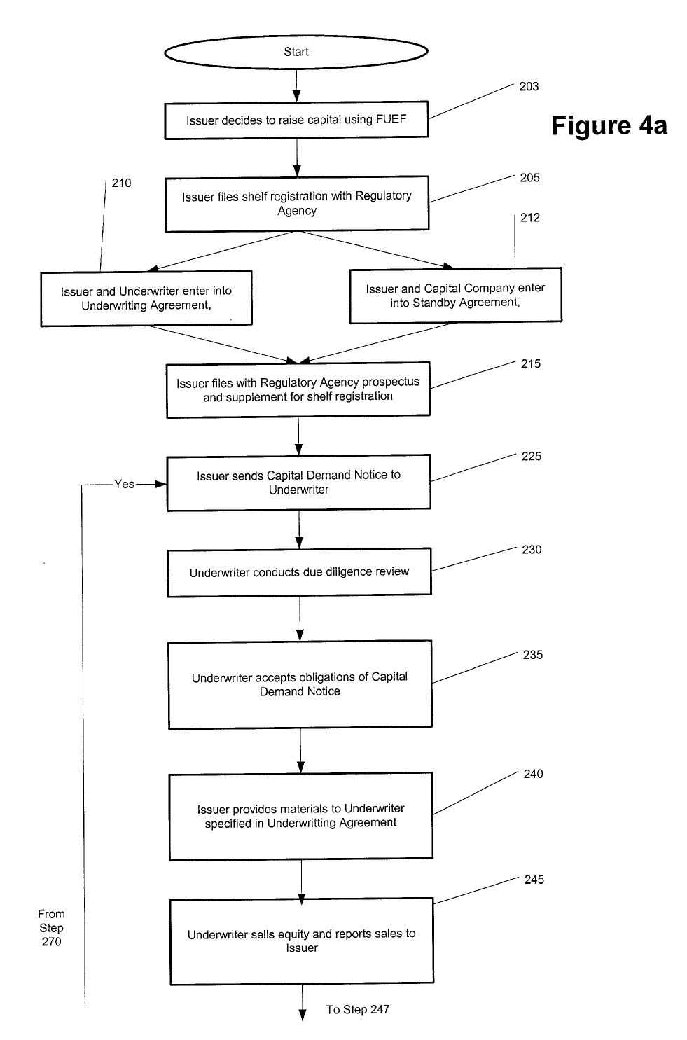

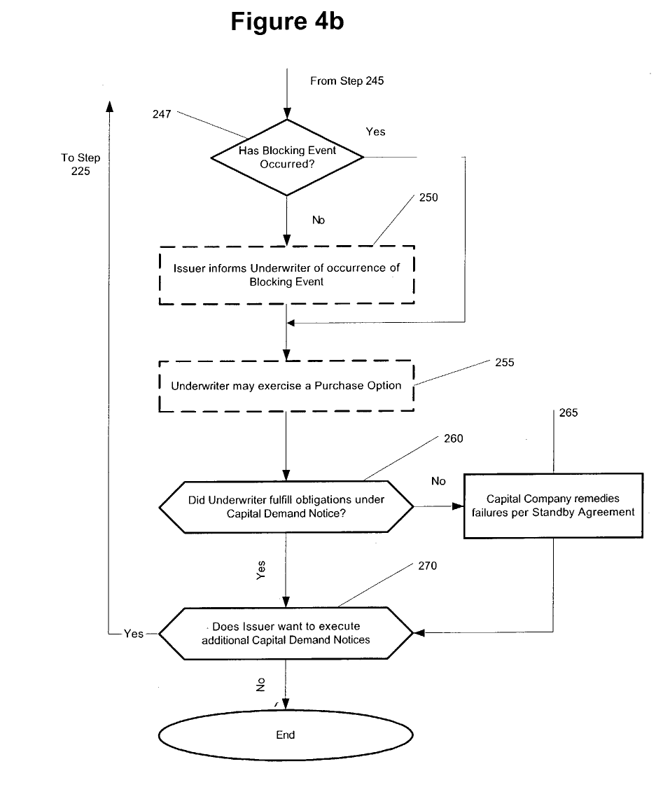

The present invention relates to a system which gives a Issuer 10 greater control over the process of rasing equity capital. In particular, a Firm Underwritten Equity FaciLity (“FUEL”) process, as shown in FIGS. 3 and 4, streamlines the offering process for the Issuer 10 and allows the Issuer 10 to exercise more complete control over the Offerings. In addition, under the system according to the present invention the Issuer 10 will receive a firm commitment that it may raise capital, if so desired, in accordance with the Issuer 10's agreement with the Underwriter 20.

FIG. 3 shows an exemplary system for the FUEL process according to the invention. Participants in the system according to the present invention may include a Issuer 10 seeking capital, an Underwriter 20 willing to raise the capital and a Capital Company 25. The Capital Company 25 provides an assurance to the Issuer 10 that if the Underwriter 20 fails to sell the Issuer 10's shares according to a predetermined agreement, the Capital Company 25 will remedy the Underwriter 20's failure.

As shown in FIGS. 4a and 4b, once the Issuer 10 has determined that it would like the control and flexibility of the FUEL process (step 203), the Issuer 10 may file a shelf registration statement (e.g., an S-3 registration) with a Regulatory Agency 30 for a primary issuance of common stock (step 205). Alternately, the Issuer 10 may utilized an existing shelf registration. The registration statement may or may not include agreements with the Underwriter 20 or the Capital Company 25. When approved by the Regulatory Agency, the registration statement is declared effective.

Subsequently, the Issuer 10 and the Underwriter 20 negotiate an Underwriting Agreement (step 210). In the Underwriting Agreement, the Issuer 10 and the Underwriter 20 must describe in detail how the Underwriter 20 will sell shares of stock in the Issuer 10. In particular, the Underwriting Agreement may set forward multiple terms, conditions, structures and options for the Offer using key variables (e.g., price, volume and timing of the Offering) in any number of variations. The multiple terms, conditions, structures and options may be tied to a particular event such as, e.g., a predefined drop in the Dow Jones Index, a predetermined increase in the price the Issuer 10's stock, etc. The Underwriting Agreement may also specify that the Underwriter 20 agrees to sell the shares on the behalf of the Issuer 10 on “a best effort” basis.

The Underwriting Agreement may specify a time period (“Commitment Period”) during which it is in effect. During the Commitment Period, the Issuer 10 may instruct the Underwriter 20 to raise capital in accordance with the terms and conditions set forth in the Underwriting Agreement or in the Capital Demand Notice. The Commitment Period may be of a predetermined length (e.g., one year) or it may expire upon occurrence of predefined events. For example, the Underwriting Agreement may terminate within 60 days of the sale by the Underwriter 20 of one million shares of the Issuer 10's stock.

In addition, the Underwriting Agreement may indicate that whenever the Issuer 10 wants to raise capital by selling securities, the Issuer 10 will send a Capital Demand Notice to the Underwriter 20. The Capital Demand Notice may be issued at any time during the Commitment Period. However, there may be a predefined time period between two consecutive Capital Demand Notices. Such predefined time period may be specified in the Underwriting Agreement and may vary depending, e.g., on market conditions or an internal event of the Issuer 10.

The Capital Demand Notice may specify (a) a time period for the offering (“Offering Period”); (b) a minimum price at which the shares are to be offered (“Floor Price”); and (c) a minimum amount of capital to be offered during the Offering Period (“Offering Volume”). For example, the Capital Demand Notice may specify an Offering Period of ten days beginning on Jul. 20, 2000 and an Offering Volume of one million shares at a Floor Price of $24.00 per share. The Issuer 10 may set each of the terms of the Offering for each Capital Demand Notice. Depending on the specific terms of the Capital Demand Notice, the Underwriter 20 may be required to sell a predetermined percentage of the shares traded at or above the Floor Price during the Offering Period. The Capital Demand Notice may specify, for example, minimum and maximum capital amounts to be raised by the Underwriter, under specified conditions, during the Offering Period. The Capital Demand Notice is considered effective upon delivery by the Issuer 10 to the Underwriter 20.

The Underwriter Agreement may also specify that the Underwriter 20 will perform a Due Diligence on the Issuer 10 and specify the terms of such review. For example, the Underwriting Agreement may specify the conditions under which the Due Diligence is to be performed and the criteria the Underwriter 20 may use to determine whether or not the results are satisfactory.

The Underwriting Agreement may also specify a list of documents to be supplied by the Issuer 10 to the Underwriter 20 or which must otherwise be obtained by the Underwriter 20 to complete the due diligence review.

Furthermore, the Underwriting Agreement may specify a period of time allowed to the Underwriter 20 for the performance of the due diligence review of the Issuer 10 as related to each particular Capital Demand Notice (“the Due Diligence Period”). In particular, the Underwriting Agreement may specify, for example, when the Due Diligence Period is to begin and end, or otherwise define the length of such period. For example, the Underwriting Agreement may specify that the Due Diligence Period must end before the Offering Period begins. Alternatively, the Underwriting Agreement may specify that the Due Diligence Period for a particular Capital Demand Notice begins when the Issuer 10 delivers or otherwise makes available all materials necessary for performing the due diligence review. For example, the Due Diligence Period may be specified as seven business days long, beginning on a specified day.

Simultaneously with the Underwriting Agreement, the Issuer 10 executes with a Capital Company 25 a Standby Agreement that provides that the Capital Company 25 will guarantee fulfillment of the Underwriting Agreement in case the Underwriter 20 fails to comply with its obligations under the Capital Demand Notice. For example, if the Capital Demand Notice specifies that the Underwriter 20 has agreed to sell 2,000 shares of stock in the Issuer 10 within thirty days but, due to market conditions, the Underwriter 20 is able to sell only 1,200 shares, the Capital Company 25 will be notified and, according to the Standby Agreement, will be required to purchase the remaining 800 shares at the Floor Price or other price specified in the Capital Demand Notice.

Those skilled in the art will understand that the Standby Agreement may be “flexible” and may include a plurality of conditions and terms. For example, the Standby Agreement may state that, if the market price for the shares of stock in the Issuer 10 drops below a predefined mark, then the Capital Company 25 may have to buy shares at a ten percent discount in comparison to the price specified in the Capital Demand Notice.

After the Underwriting Agreement and the Standby Agreement have been executed, the Issuer 10 is required to file with the Regulatory Agency 30 a prospectus and a supplement (i.e., a post-effective amendment) to the previously filed shelf registration (step 215).

At this point, the Issuer 10 has complete control over the key terms of the Offering. The Issuer 10 is under no obligation to utilize the FUEL process once it is in place. If the Issuer 10 desires to use the FUEL process, the Issuer 10 sends a Capital Demand Notice to the Underwriter 20 in accordance with the Underwriting Agreement (step 225). The Capital Demand Notice generally indicates the Floor Price, the Offering Volume and the Offering Period for this particular Capital Demand Notice.

Upon receipt of the Capital Demand Notice, the Underwriter 20 conducts the due diligence review of the Issuer 10 during the Due Diligence Period specified in the Underwriting Agreement (step 230). During the due diligence review, the Underwriter 20 may review, for example, (1) whether the Issuer 10 has an effective registration statement with the Regulatory Agency 30; (2) whether the Issuer 10's representations and warranties are accurate; (3) the performance of the Issuer 10 and its prospects for the future; (4) the existence of adverse legal actions, rulings, injunctions, etc.; and (5) the existence of regulatory suspensions, etc.

Upon satisfactory completion of the due diligence review of the Issuer 10, the Underwriter 20 accepts the obligations of the Capital Demand Notice under the terms, conditions, structures and options of the Underwriting Agreement (step 235). At this point the Issuer 10 may be required to provide certain documents and materials to the Underwriter 20 before the Underwriter 20 begins selling the shares (step 240). For example, the Issuer 10 may be required to deliver an Officer's Certificate, predefined Legal Opinions, an Accountant's Letter, Transfer Agent Instructions, Clearing Broker Instructions, Issuer 10's bank/brokerage account, etc.

In step 245, the Underwriter 20 sells shares in the Issuer 10 during the Offering Period. As described above, the Offering Period, as well as other terms, may be specified in the Underwriting Agreement. For example, the Offering Period may start a day after the Issuer 10 has delivered all of the required papers specified in step 240 and continue for a length of time specified in the Underwriting Agreement.

Upon selling a portion of the shares of stock in the Issuer 10, the net capital is delivered to the Issuer 10 via a predetermined mechanism. For example, the raised capital may be automatically deposited in the brokerage account of the Issuer 10 with the Underwriter 20. The net capital may, for example, be equal to a number of shares sold multiplied by the selling price, minus the Underwriter 20's commission.

During the Offering Period, the Underwriter 20 may deliver to the Issuer 10 Underwriter Sales Notices as the shares are sold. An Underwriter Sales Notice may be provided to the Issuer 10 each day or at predefined time periods during the Offering Period. The Underwriter Sales Notices indicates the actual volume and price of the shares sold during the time period to which it pertains, and additional information including, e.g. the Underwriter 20's commission, etc. The Underwriter 20's commission may be calculated based upon a formula agreed upon and specified, e.g., in the Underwriting Agreement.

During the Offering Period, the Issuer 10 may be required to notify the Underwriter 20 of the occurrence of any of a plurality of predefined Blocking Events (step 250). A Blocking Event may, for example, be an event which discharges the Underwriter 20 partially or completely from its obligations under the current Capital Demand Notice. For example, a withdrawal or suspension of the Issuer 10's registration by the Regulatory Agency 30; a predetermined breach of the Underwriting Agreement by the Issuer 10; failure of the Issuer 10 to deliver shares; the occurrence of predefined market conditions, etc. may be set forth in the Underwriting Agreement as Blocking Events. Whether or not the Issuer 10 is required to make such notice, or the conditions and content of such notice may also optionally be defined in the Underwriting Agreement.

As mentioned above, a particular Blocking Event may completely or partially discharge certain obligations of the Underwriter 20. For example, the Underwriting Agreement may specify a drop in a particular market index of 10% or more as a Blocking Event and may further specify that, upon occurrence of this Blocking Event, the Underwriter 20 is required to sell only a predefined portion of the shares specified in the Capital Demand Notice. The Underwriting Agreement may further specify that the Issuer 10 has an opportunity to remedy specific Blocking Events, providing specifics for the method and timing of acceptable remedies and the required reaction of the Underwriter 20 in response to remedy employed by the Issuer 10. For example, if the Regulatory Agency 30 suspends the Issuer 10's registration, the Issuer 10 may have ten days to remedy the suspension by obtaining a reinstatement of the registration or a vacation of the previous suspension of registration. The Underwriting Agreement may then specify new time limits for the actions of the Underwriter 20 in response to the completion of this remedy.

During the Offering Period, the Underwriter 20 may exercise a Purchase Option by delivering a Purchasing Option Notice to the Issuer 10 (step 255). The Purchase Option which may be detailed in the Underwriting Agreement, defines an Underwriter 10's right to purchase additional shares above the amount of shares which, under the terms of the Capital Demand Notice, the Underwriter 20 is required to sell.

By the end of the Offering Period, the Issuer 10 determines whether the Underwriter 20 has fulfilled the terms of the Capital Demand Notice (step 260). For example, the Issuer 10 may check whether the Underwriter 20 has sold the Offering Volume specified in the Capital Demand Notice. If the Underwriter 20 has failed to sell the Offering Volume specified in the Capital Demand Notice, the Capital Company 25 is notified and is required to remedy the Underwriter's shortcomings (step 265) in accord with the Standby Agreement. For example, if the Underwriter 20 has sold less than the Offering Volume, the Standby Agreement may specify that the Capital Company 20 is obligated to purchase the remaining amount of shares or perform other steps defined in the Standby Agreement to remedy the Underwriter 20's failure.

The Issuer 10 may repeat steps 225 through 265 as often as desired by executing additional Capital Demand Notices with new terms at any desired Floor Price, Offering Volume and for any desired Offering Period (step 270).

One of the advantages of the present invention is that it provides the Issuer 10 with system under which a firm commitment to raise capital (secured by the Standby Agreement) is available to the Issuer 10 on terms which the Issuer 10 controls. In particular, the Issuer 10 sets the price, timing, volume and amount of capital to be raised. The Issuer 10 may, for example, determine multiple points at which to sell its equity.

In addition, the present invention simplifies the process of raising capital for the Issuer 10. This system facilitates compliance with existing laws and regulations, and may avoid supplemental filings required by current capital-rasing methods under which some of the relevant numbers (e.g., share price and number of shares) in the prospectus may not be definitively calculated prior to completion of the Offering. Furthermore, the present invention allows for a completely scalable product offering that can be rolled out en masse with essentially the same terms.

Those skilled in the art will recognize that the system and method according to the present invention may be implemented electronically via, e.g, a communications network such as the Internet. In other words, communications between the Issuer 10, the Underwriter 20, the Capital Company 25, the Regulatory Agency 30 and the public markets 40 may be made via the Internet or other data network through the transmission of digital files including the required data. In addition, any or all of the transactions making up this system (e.g., the selling of shares, the transferring of raised capital, etc.) may be completed electronically.

Thus, the FUEL process allows the Underwriter 20 to act as an agent for the Issuer 10 while eliminating any motivation to act against the interests of the Issuer 10. As described above, under prior arrangements where an underwriter acts as a principal, an underwriter may make money without raising any capital for an issuer by selling the issuer's shares short to apply downward pressure on the price of those shares. Then, when the price of issuer's shares has fallen below the floor price, the underwriter may cover the short sales by purchasing at the deflated price. The present system (i.e., FUEL) completely eliminates this conflict of interest and ensures that the Issuer 10 will raise the desired amount of capital on the terms set forth in the Capital Demand Notice. Furthermore, the Issuer 10 may open an account with the Underwriter 20 and can then monitor the progress and terms of the sale of its equity on a daily basis. Under the prior system, the Issuer 10 was unable to monitor the progress of the private placements until after the transactions were complete and an average sale price was calculated by the underwriter and communicated to the issuer.

There are many modifications to the present invention which will be apparent to those skilled in the art without departing from the teaching of the present invention. The embodiments disclosed herein are for illustrative purposes only and are not intended to describe the bounds of the present invention which is to be limited only by the scope of the claims appended hereto.

What is claimed is:

1. A method for raising capital comprising the steps of:
generating a first agreement between a first company and a second company, the first agreement granting the first company an option to obligate the second company to sell a predetermined volume of equity in the first company according to a predefined price structure, during a predefined time period; and
generating a second agreement between the first company and a third company, wherein, under the second agreement the third company is obligated to remedy a predefined failure of the second company to fulfill its obligations under the first agreement.

2. The method according to claim 1, wherein the first and second agreements take effect substantially simultaneously.

3. The method according to claim 1 wherein, when the predefined failure of the second company is a failure of the second company to sell the predetermined volume of equity in the first company during the predefined time period.

4. The method according to claim 3, wherein the third company is obligated by the second agreement to remedy the predefined failure of the second company by purchasing an amount of equity in the first company equal to a difference between a volume of equity in the first company sold by the second company under the first agreement and the predetermined volume of equity.

5. The method according to claim 4, wherein a price at which the third company is obligated to purchase the amount of equity in the first company equal to the difference between the volume of equity in the first company sold by the second company under the first agreement and the predetermined volume of equity is determined based on the second agreement.

6. A method by which an Issuer of equity may raise capital by selling the equity, comprising the steps of:
filing by the Issuer a registration with a government agency for the sale of equity in the Issuer;
generating an Underwriting Agreement between the Company and an Underwriter, the Underwriting Agreement setting forth terms and conditions under which the Underwriter will sell the Issuer's equity;
generating a Standby Agreement between the Issuer and a Capital Company obligating the Capital Company to remedy a predefined failure of the Underwriter under the Underwriting Agreement;
forwarding from the Issuer to the Underwriter a Capital Demand Notice setting forth terms for a particular sale of the Issuer's equity;
indicating by the Underwriter one of an acceptance and a rejection of the Capital Demand Notice based on a review of information regarding the Issuer and the Capital Demand Notice; and
obtaining from the Capital Company a remedy, upon the occurrence of the predefined failure of the Underwriter under the Underwriting Agreement.

7. The method according to claim 6, wherein the criteria on which the Underwriter may indicate the one of acceptance and rejection of a Capital Demand Notice are set forth in the Underwriting Agreement.

8. The method according to claim 6, wherein the predefined failure of the Underwriter is a failure to sell a volume of equity set forth in an accepted Capital Demand Notice.

9. The method according to claim 8, wherein the Standby Agreement obligates the Capital Company to remedy the predefined failure of the Underwriter by purchasing an amount of equity in the Issuer equal to a difference between a volume of equity actually sold by the Underwriter in accord with the accepted Capital Demand Notice and the volume of equity set forth in the accepted Capital Demand Notice.

10. The method according to claim 9, wherein a price at which the Capital Company is obligated to purchase the volume of equity in the Issuer equal to the difference between the volume of equity actually sold by the Underwriter in accord with the accepted Capital Demand Notice and the volume of equity set forth in the accepted Capital Demand Notice is determined based on the Standby Agreement.

11. The method according to claim 6, wherein the Underwriting Agreement sets forth a Blocking Event, wherein, upon occurrence of the Blocking Event, the obligations of the Underwriter are one of completely and partially discharged.

12. The method according to claim 6, wherein the Underwriting Agreement sets forth terms and conditions under which the Underwriter may purchase an additional volume of equity above that set forth in an accepted Capital Demand Notice.

13. The method according to claim 11, wherein the Blocking Event corresponds to a predetermined change in a market price of the Issuer's equity.

14. The method according to claim 11, wherein the Blocking Event corresponds to a predetermined change in a market index value.

15. The method according to claim 6, wherein, up to acceptance of a Capital Demand Notice, the Issuer maintains control of the terms and conditions of sales of equity under the Underwriting Agreement.
